(19) United States
(12) Patent Application Publication
(10) Pub. No.: US 2026/0161982 A1
(43) Pub. Date: Jun. 11, 2026

(54) INFORMATION PROCESSING DEVICE, INFORMATION PROCESSING METHOD, AND RECORDING MEDIUM

(71) Applicant: NEC Corporation, Tokyo (JP)

(72) Inventors: Yoichi SASAKI, Tokyo (JP); Yuzuru OKAJIMA, Tokyo (JP)

(73) Assignee: NEC Corporation, Tokyo (JP)

(21) Appl. No.: 19/399,893

(22) Filed: Nov. 25, 2025

(30) Foreign Application Priority Data
Dec. 10, 2024 (JP) 2024-215111

(51) Int. Cl. G06N 7/01

(52) U.S. Cl. CPC G06N 7/01

(57) ABSTRACT

In an information processing device, an input unit acquires a set, features included in the set, and two or more functions that return a value to an optional subset of the set. The marginal contribution calculation unit outputs, as a marginal contribution, a difference between a first output value output by the functions in a case where a first subset of the set is input and a second output value output by the functions in a case where a second subset obtained by adding a feature to the first subset is input. The difference output unit calculates and outputs an index indicating a difference between the functions based on the marginal contribution.

### INCORPORATION BY REFERENCE

This application is based upon and claims the benefit of priority from Japanese Patent Application 2024-215111, filed on Dec. 10, 2024, the disclosure of which is incorporated herein in its entirety by reference.

### TECHNICAL FIELD

The present disclosure relates to a technique for evaluating a behavior of prediction by a machine learning model.

### BACKGROUND ART

In a case of using a machine learning model for various tasks that involve decision-making, not only prediction performance but also interpretability is required. In recent years, attention has been paid to a post-hoc explanation technique in which, when an instance of interest is given, an explanation of prediction of a model for the instance is added later. Known post-hoc explanation techniques include Shapley Additive explanation (SHAP). A Japanese patent application laid-open under No. JP 2023-5697A discloses a technique for calculating a contribution degree of data to a prediction result using SHAP in a device that supports diagnosis by a doctor with a machine learning model.

### SUMMARY

On the other hand, there is a scene in which it is desired to know not only explanations of individual instances but also an explanation of a difference in prediction between a plurality of instances that has been given. However, simply evaluating a difference in feature importance between instances of interest using explanation techniques such as SHAP does not allow for consideration of a difference due to an interaction between features, and is therefore insufficient.

It is an object of the present disclosure to provide an information processing device capable of comparing and evaluating behaviors of models at the time of prediction between instances of interest in consideration of a difference due to an interaction between features.

According to an example aspect of the present invention, there is provided an information processing device comprising:
an input means for acquiring a set, features included in the set, and two or more functions that return a value to an optional subset of the set;
a marginal contribution calculation means for calculating, as a marginal contribution, a difference between a first output value output by the functions in a case where a first subset of the set is input and a second output value output by the functions in a case where a second subset obtained by adding a feature to the first subset is input; and
a difference output means for calculating and outputting an index indicating a difference between the functions based on the marginal contribution.

According to another example aspect of the present invention, there is provided an information processing method executed by a computer, the method comprising:
acquiring a set, features included in the set, and two or more functions that return a value to an optional subset of the set;
calculating, as a marginal contribution, a difference between a first output value output by the functions in a case where a first subset of the set is input and a second output value output by the functions in a case where a second subset obtained by adding a feature to the first subset is input; and
calculating and outputting an index indicating a difference between the functions based on the marginal contribution.

According to still another example aspect of the present invention, there is provided a non-transitory computer-readable recording medium storing a program, the program causing a computer to execute processing comprising:
acquiring a set, features included in the set, and two or more functions that return a value to an optional subset of the set;
calculating, as a marginal contribution, a difference between a first output value output by the functions in a case where a first subset of the set is input and a second output value output by the functions in a case where a second subset obtained by adding a feature to the first subset is input; and
calculating and outputting an index indicating a difference between the functions based on the marginal contribution.

According to the present disclosure, it is possible to compare and evaluate behaviors of models at the time of prediction between instances of interest in consideration of a difference due to an interaction between features.

### BRIEF DESCRIPTION OF THE DRAWINGS

FIGS. 1A and 1B illustrate an example of a cooperative game;

FIGS. 2A and 2B illustrate examples in which an error in an interaction between features is ignored when prediction is evaluated;

FIG. 3 illustrates a method of evaluating prediction models by an existing technique;

FIG. 4 illustrates a method of evaluating prediction models by a proposed technique;

FIG. 5 illustrates an overall configuration of an information processing device according to an example embodiment;

FIG. 6 is a block diagram illustrating a hardware configuration of the information processing device;

FIG. 7 is a block diagram illustrating a functional configuration of the information processing device;

FIG. 8 is a flowchart of function comparison processing executed by the information processing device;

FIGS. 9A and 9B illustrate a display example of an explanation of a difference in prediction between instances;

FIG. 10 is a block diagram illustrating a functional configuration of another information processing device; and

FIG. 11 is a flowchart of processing by the another information processing device.

### EXAMPLE EMBODIMENTS

Hereinafter, preferred example embodiments of the present disclosure will be described with reference to the drawings.

### RELATED ART

Prior to the description of the example embodiments, a related art will be described.

### [Shapley Value]

A Shapley value is a method for fairly distributing each player's contribution to the entire game in a cooperative game theory. The Shapley value is represented by, in consideration of a participation order (hereinafter also referred to as “intervention order”) of all the players, an expected value (that is, average) of a marginal contribution given to the entire game by each player in the intervention order.

In a cooperative game by a set of a plurality of players N={1, . . . , N}, a characteristic function v(S) that returns a real number for a subset S⊆N of the plurality of players is defined. The marginal contribution of a player i to the subset S is the contribution generated when the subset S exists and the player i joins the subset S, and is expressed by the following formula.

$$Marginal contribution of player i = v ( S ⋃ \{ i \} ) - v ( S )$$

A Shapley value φᵢ for the player i∈N is defined by the expected value of the marginal contribution of the player i in a case where the players are added in a uniform random order, and is expressed by the following formula.

$${ϕ}_{i} = {\sum }_{S ⊆ N ∖ \{ i \}} \frac{\vert S \vert ! ( n - \vert S \vert - 1 ) !}{n !} ( v ( S ⋃ \{ i \} ) - v ( S ) ) \qquad ( 1 )$$

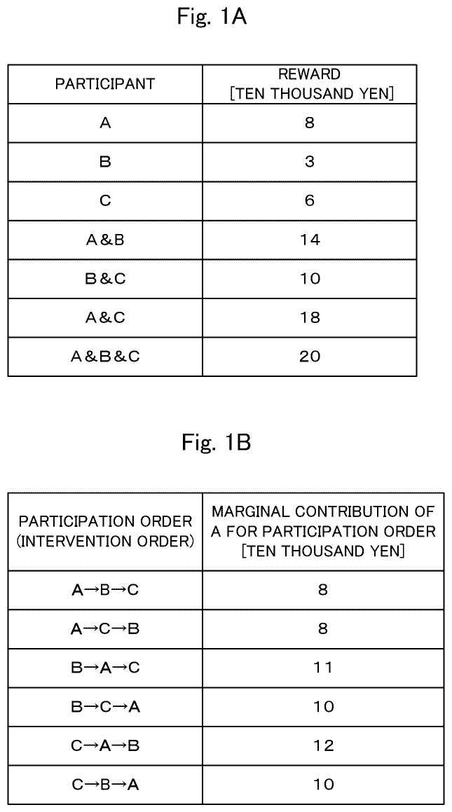

Specific examples will be described below. As an example of the cooperative game, a part-time job game performed by three players A, B, and C will be considered. FIG. 1A illustrates a reward given in a case where each player participates in a target part-time job. For example, in a case where the player A takes on the target part-time job alone, a reward of 80,000 yen is given, and in a case where the players A and B take on the target part-time job, a reward of 140,000 yen is given.

Here, in a case where a set of prior participants is the subset S described previously and the player A participates in the subset S, the reward given to the player A is considered to be as follows.
In a case where the player A participates in a state where there is no prior participant, the reward given to the player A is 8−0=8 (ten thousand yen).
In a case where the player A participates in a state where the player B is the sole prior participant, the reward given to the player A is 14−3=11 (ten thousand yen).
In a case where the player A participates in a state where the player Cis the sole prior participant, the reward given to the player A is 18−6=12 (ten thousand yen).
In a case where the player A participates in a state where the prior participants are the players B and C, the reward given to the player A is 20−10=10 (ten thousand yen).

In this way, the reward given to the player A for the prior participants, that is, the marginal contribution, is calculated for all the participation orders as illustrated in FIG. 1B. Thus, the Shapley value Ø i of the player A is the expected value (average) of the reward in all the participation orders in a case where the player A participates, and is calculated as follows from FIG. 1B.

$${ϕ}_{i} = ( 8 + 8 + 11 + 10 + 12 + 10 ) / 6 = 9.8 ( ten thousand yen )$$

### [SHAP]

SHAP is application of a Shapley value for the purpose of improving interpretability of machine learning, and a contribution degree of each feature is calculated in order to explain a prediction result of a machine learning model. SHAP indicates, by feature importance, a local explanation of a prediction f(x) of an instance of interest x∈Rⁿ for a prediction model f: Rⁿ→R. SHAP is a type of Shapley value, and the Shapley value and SHAP have the following correspondence relationship.
The players i are regarded as features i, and the player set N is regarded as a feature set.
One game is defined for the instance of interest x, and the characteristic function of this game is represented by vₓ.
For the feature subset S∈N, a characteristic function vₓ(S) is expressed by the following Formula (2):

$${v}_{x} ( S ) = {E}_{X} [ f ( {x}_{S} , {X}_{N \backslash S} ) ] \qquad ( 2 )$$

In a background data set B, the characteristic function vₓ(S) is expressed by the following Formula (3).

$${v}_{x} ( S ) = {v}_{x} ( S \vert B ) = \frac{1}{\vert B \vert} {\sum }_{b ∈ B} f ( {x}_{S} , {b}_{N \backslash S} ) \qquad ( 3 )$$

It is assumed that x_{S}={xᵢ: i∈S} holds, and X_{S} represents a corresponding random variable.

The marginal contribution of the feature i for the subset S is expressed by the following formula.

$$Marginal contribution of feature i = {v}_{x} ( S ⋃ \{ i \} ) - {v}_{x} ( S )$$

This is the contribution generated when an input value has been changed to a feature value x_{S} of an instance of interest corresponding to the subset S, and the feature value is further changed to a feature value xᵢ.

A SHAP value φᵢ corresponding to the feature i is defined by an expected value φᵢ of the marginal contribution of the feature i when the features are added in a uniform random order, and is expressed by the following formula.

$${ϕ}_{i} = {\sum }_{S ⊆ N \backslash \{ i \}} \frac{\vert S \vert ! ( n - \vert S \vert - 1 ) !}{n !} ( {v}_{x} ( S ⋃ \{ i \} ) - {v}_{x} ( S ) ) \qquad ( 4 )$$

A vector φ=(φ₁, . . . , φₙ) in which SHAP values corresponding to all the features i are arranged is hereinafter referred to as a SHAP vector. The following document proposes a technique of performing clustering using a SHAP vector obtained from the feature of each sample. In this technique, a cluster can be analyzed from a viewpoint of which feature is important for an objective variable.
(Document 1) Explainable AI for Trees: From Local Explanations to Global Understanding, Scott M. Lundberg, Gabriel Erion, Hugh Chen, Alex DeGrave, Jordan M. Prutkin, Bala Nair, Ronit Katz, Jonathan Himmelfarb, Nisha Bansal, Su-In Lee, https://doi.org/10.48550/arXiv.1905.04610

### Problem

The evaluation using the SHAP values has a problem of lacking information regarding an interaction between features. Since the marginal contribution in the SHAP value is affected by other features, the marginal contribution of a certain feature in an intervention order A is different from the marginal contribution in an intervention order B. For example, the intervention orders A and B are as follows.
Intervention order A: feature 1→feature 3→feature 2
Intervention order B: feature 2→feature 1→feature 3

Here, in a case where there is an interaction between the feature 1 and the feature 2, the marginal contribution of the feature 1 in the intervention order B is different from the marginal contribution of the feature 1 in the intervention order A. However, since a Shapley value is averaged for all the intervention orders, there is no information regarding a fluctuation (hereinafter also referred to as “variance”) of the marginal contribution that depends on the intervention order. The variance of the marginal contribution that depends on the intervention order increases in a case where there is an interaction between the features. Thus, in a case where a difference in the Shapley value is simply used for an explanation of a prediction error between a plurality of instances such as the clustering in Document 1 described previously, an error in the interaction between the features is ignored when the prediction error is evaluated.

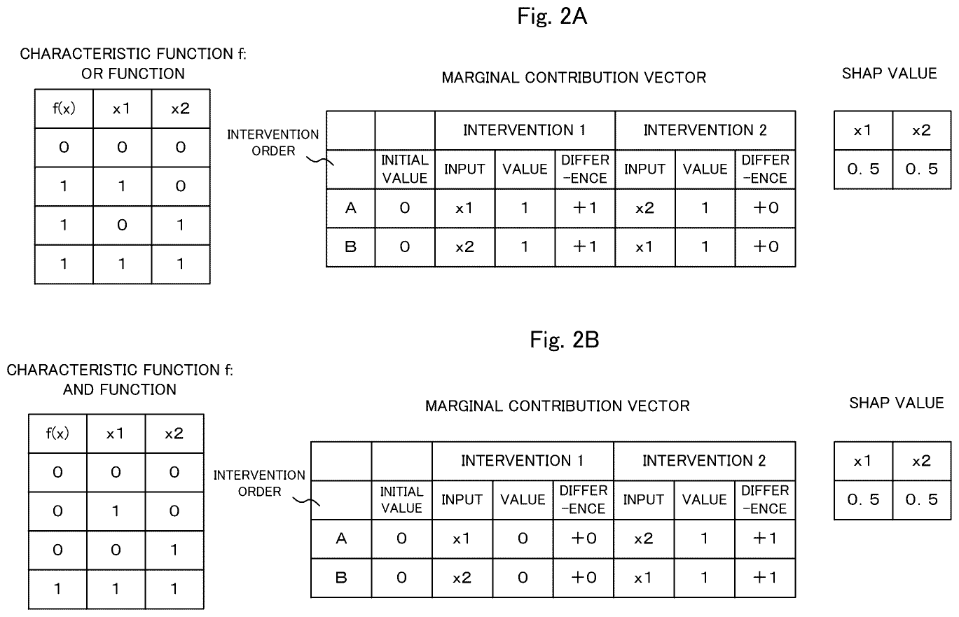

FIGS. 2A and 2B illustrate examples in which the error in the interaction between the features is ignored when evaluation is performed. In the example in FIG. 2A, a characteristic function f corresponding to a prediction model is an OR function, and inputs are features x1 and x2. For sake of simplicity, an initial value is set to 0. In a case where the features are input in the order of x1→x2 in accordance with the intervention order A, the marginal contribution of the feature x1 is “+1”. On the other hand, in a case where the features are input in the order of x2→x1 in accordance with the intervention order B, the marginal contribution of the feature x1 is “0”. Thus, the SHAP value is “0.5”, which is the average marginal contribution of the feature x1.

In the example in FIG. 2B, the characteristic function f corresponding to the prediction model is an AND function, and inputs are the features x1 and x2. For sake of simplicity, the initial value is set to 0. In a case where the features are input in the order of x1→x2 in accordance with the intervention order A, the marginal contribution of the feature x1 is “0”. On the other hand, in a case where the features are input in the order of x2→x1 in accordance with the intervention order B, the marginal contribution of the feature x1 is “+1”. Thus, the SHAP value is “0.5”, which is the average marginal contribution of the feature x1.

In this way, in a case where the characteristic function is different, the marginal contribution of each feature differs depending on the intervention order. However, the marginal contribution of each feature is averaged by taking the SHAP value, and the SHAP value becomes the same in any characteristic function. That is, the error in the interaction caused by the intervention order is ignored.

### Proposed Technique

### Description of Concept

As described above, a Shapley value is an expected value, that is, an average value, of a marginal contribution in a case where an optional intervention order is in equal probability. Thus, in evaluating behaviors of models at time of prediction between instances of interest, it is not possible to take into consideration a difference due to an interaction between features in a case of a technique of simply comparing Shapley values.

Specifically, cooperative games are considered as prediction models, and a difference (also referred to as “dissimilarity”) between cooperative games A and B is evaluated. In the technique of simply comparing Shapley values, the expected value of the marginal contribution for the intervention order is calculated for each of the cooperative games A and B, and the difference therebetween is obtained. However, in this technique, it is not possible to take into consideration the difference due to the interaction between the features caused by the intervention order.

Thus, in a proposed technique, for the cooperative games A and B corresponding to the prediction models, a “difference in the marginal contribution” of each feature is obtained for all the intervention orders, and an expected value of the obtained “difference in the marginal contribution” is calculated. This makes it possible to take into consideration the difference due to the interaction between the features caused by the intervention order.

In the following description, a technique of comparing values obtained by averaging marginal contributions such as Shapley values and SHAP values when two prediction models are compared and evaluated is referred to as an “existing technique”, and a method of comparing average values of the “differences in the marginal contribution” is referred to as the “proposed technique”.

### Specific Instances

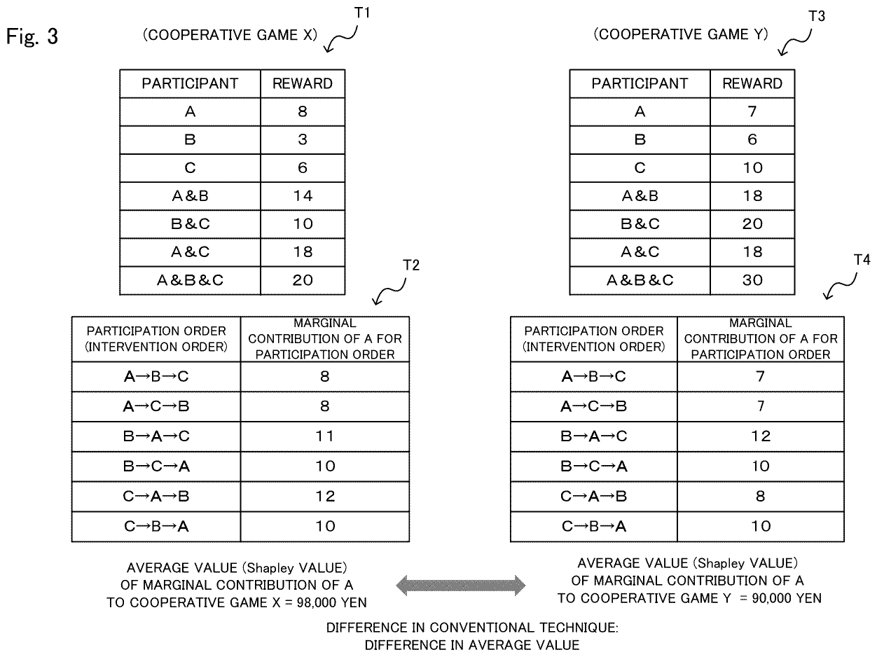

FIG. 3 illustrates a method of evaluating prediction models by the existing technique. Now, cooperative games X and Y are considered as prediction models to be evaluated. For the cooperative game X, a relationship between each participant and the reward is shown in Table T1, and a relationship between the participation order (intervention order) and the marginal contribution of a participant A is shown in Table T2. Similarly, for the cooperative game Y, the relationship between each participant and the reward is shown in Table T3, and the relationship between the participation order (intervention order) and the marginal contribution of the participant A is shown in Table T4.

In the existing technique, for each cooperative game, first, an average value of the marginal contribution of the participant A in all the intervention orders is calculated and compared. As illustrated in FIG. 3, in the existing technique, 98,000 yen, which is the average value of the marginal contribution of the participant A to the cooperative game X, is compared with 90,000 yen, which is the average value of the marginal contribution of the participant A to the cooperative game Y, and the cooperative games X and Y are evaluated. However, as described previously, as a result of averaging the marginal contribution, the interaction between the features caused by the intervention order gets buried without emerging in the average value, and is not taken into consideration in comparative evaluation.

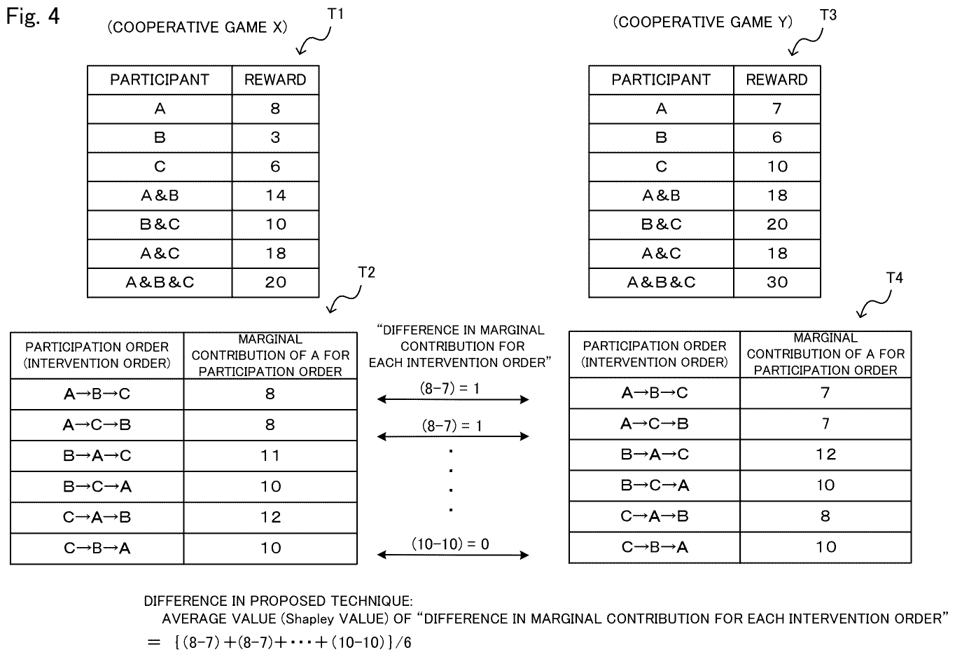

FIG. 4 illustrates a method of evaluating prediction models by the proposed technique. Similarly to the existing technique, the cooperative games X and Y are considered as prediction models to be evaluated. For the cooperative game X, the relationship between each participant and the reward is shown in Table T1, and the relationship between the participation order (intervention order) and the marginal contribution of the participant A is shown in Table T2. For the cooperative game Y, the relationship between each participant and the reward is shown in Table T3, and the relationship between the participation order (intervention order) and the marginal contribution of the participant A is shown in Table T4. Tables T1 to T4 are similar to those in FIG. 3.

The proposed technique first calculates, for each intervention order, a difference between the marginal contribution of the participant A in the cooperative game X and the marginal contribution of the participant A in the cooperative game Y. Then, in the proposed technique, an average value of the obtained “difference in the marginal contribution” is calculated, and the cooperative games X and Y are evaluated based on the obtained average value. Since the “difference in the marginal contribution” is a value including the interaction between the features that emerges in the marginal contribution in each intervention order, the average value of the “difference in the marginal contribution” finally obtained is a value including the interaction between the features. Thus, according to the proposed technique, it is possible to compare the prediction models in consideration of the interaction between the features.

### [Calculation Method]

Next, a method for calculating the difference in the marginal contribution by the proposed technique will be described.

### (i) in Case of Shapley Value

First, a Shapley value is rewritten as an expected value of the intervention order. An optional permutation π:{1, . . . , n}→{1, . . . , n} is referred to as an intervention order, and all the intervention orders are defined by a set II. The marginal contribution of the player i in the cooperative game A and an intervention order π is defined by the following formula.

$${Δ}_{π , A}^{( i )} = {v}_{A} ( {S}_{π , i} ⋃ \{ i \} ) - {v}_{A} ( {S}_{π , i} ) \qquad ( 5 )$$

When the intervention order π and the player i are given, a set of players in the intervention order before the player i in the intervention order I is defined by the following formula.

$${S}_{π , i} = \{ {π}^{- 1} ( 1 ) , ... , {π}^{- 1} ( π ( i ) - 1 ) \} \qquad ( 6 )$$

The Shapley value of the player i is expressed by the following formula in which the expected value is taken for the intervention order T.

$${ϕ}_{i , A} = {E}_{π} [ {Δ}_{π , A}^{( i )} ] \qquad ( 7 )$$

A point here is a viewpoint of regarding, as a random variable, a marginal contribution Δ⁽ⁱ⁾_{π,A} of the player i in the cooperative game A and the intervention order π.

This Formula (7) shows such contribution that a square error between the marginal contribution and the contribution degree in the actually observed intervention order π is minimized (that is, the expected value) when it is assumed that all the intervention orders occur with equal probability.

From this viewpoint, an explanation of the difference between the cooperative games A and B is defined by the expected value of the square error between the marginal contributions Δ⁽ⁱ⁾_{π,A} and Δ⁽ⁱ⁾_{π,B} related to the intervention order, and is expressed by the following formula.

$${E}_{π} [ {( {Δ}_{π , A}^{( i )} - {Δ}_{π , B}^{( i )} )}^{2} ] \qquad ( 8 )$$

Formula (8) is an index of a difference representing a value (=expected value) at which, when the players intervene in a uniform random order, an error from the difference in the marginal contribution actually observed (=difference experienced by a user) between the cooperative games A and B is minimized. Specifically, Formula (8) is developed as follows.

$${E}_{π} [ {( {Δ}_{π , A}^{( i )} - {Δ}_{π , B}^{( i )} )}^{2} ] = {( {E}_{π} [ ( {Δ}_{π , A}^{( i )} - {Δ}_{π , B}^{( i )} ) ] )}^{2} + {V}_{π} [ ( {Δ}_{π , A}^{( i )} - {Δ}_{π , B}^{( i )} ) ] = {\underbrace{{( {ϕ}_{i , A} - {ϕ}_{i , B} )}^{2}}}_{Bias term} + {\underbrace{{V}_{π} [ ( {Δ}_{π , A}^{( i )} - {Δ}_{π , B}^{( i )} ) ]}}_{Variance term} = Difference in Sharpley values \qquad ( 9 )$$

Here, a bias term indicates a difference in the Shapley value, and a variance term indicates a difference caused by a difference in the interaction between the players, that is, information that does not allow for consideration just by measuring the difference in the Shapley value. As described above, according to the proposed technique, the cooperative games A and B can be compared and evaluated in consideration of the difference due to the interaction between the players.

### (ii) in Case of SHAP

The marginal contribution of the feature i in the instance of interest x, the intervention order π, and background data b∈B is defined by the following formula.

$${Δ}_{π , b , x}^{( i )} = {v}_{x} ( {S}_{π , i} ⋃ \{ i \} \vert b ) - {v}_{x} ( {S}_{π , i} \vert b ) \qquad ( 10 )$$

Here, the SHAP value of the feature i can be expressed by the following formula obtained by taking an expected value for the intervention order π and the background data b.

$${ϕ}_{i , x} = {E}_{π} [ {E}_{b} [ {Δ}_{π , b , x}^{( i )} ] ] = {E}_{π , b} [ {Δ}_{π , b , x}^{( i )} ] \qquad ( 11 )$$

The point here is a viewpoint of regarding, as a random variable, a marginal contribution Δ⁽ⁱ⁾_{π,b,x} of the feature i in the instance of interest x, the intervention order π, and the background data b.

This formula shows such contribution that the square error between the marginal contribution and the contribution degree in the actually observed intervention order π and the background data b is minimized (=expected value) when it is assumed that all the intervention orders and the background data are selected with equal probability.

From this viewpoint, an explanation of a difference between instances of interest x_{A} and x_{B} is defined by the expected value of the square error between marginal contributions Δ⁽ⁱ⁾_{π,b,xA} and Δ⁽ⁱ⁾_{π,b,xB} related to the intervention order and the background data, and is expressed by the following formula.

$${E}_{π , b} [ {( {Δ}_{π , b , {x}_{A}}^{( i )} - {Δ}_{π , b , {x}_{B}}^{( i )} )}^{2} ] \qquad ( 12 )$$

Formula (12) is an index of a difference representing a value (=expected value) at which, when the features are changed in a uniform random order (=intervening), an error from the difference in the marginal contribution actually observed (=difference experienced by the user) between the instances of interest X_{A} and x_{B} is minimized. Specifically, Formula (12) is developed as follows.

$${E}_{π , b} [ {( {Δ}_{π , b , {x}_{A}}^{( i )} - {Δ}_{π , b , {x}_{B}}^{( i )} )}^{2} ] = {( {E}_{π , b} [ ( {Δ}_{π , b , {x}_{A}}^{( i )} - {Δ}_{π , b , {x}_{B}}^{( i )} ) ] )}^{2} + {V}_{π , b} [ ( {Δ}_{π , b , {x}_{A}}^{( i )} - {Δ}_{π , b , {x}_{B}}^{( i )} ) ] = {\underbrace{{( {ϕ}_{i , {x}_{A}} - {ϕ}_{i , {x}_{B}} )}^{2}}}_{Bias term} + {\underbrace{{V}_{π , b} [ ( {Δ}_{π , b , {x}_{A}}^{( i )} - {Δ}_{π , b , {x}_{B}}^{( i )} ) ]}}_{Variance term} = Difference in SHAP values \qquad ( 13 )$$

Similarly to Formula (9), the bias term indicates a difference between the SHAP values, and the variance term indicates a difference caused by a difference in the interaction between the features.

While the above description shows a case where the features i are changed in the intervention order selected with a uniform probability, the proposed technique is similarly applicable to a case where the features i are changed in the intervention order selected in accordance with a specific probability distribution.

### <Information Processing Device>

Next, an information processing device to which the proposed technique is applied will be described.

### First Example Embodiment

### (Overall Configuration)

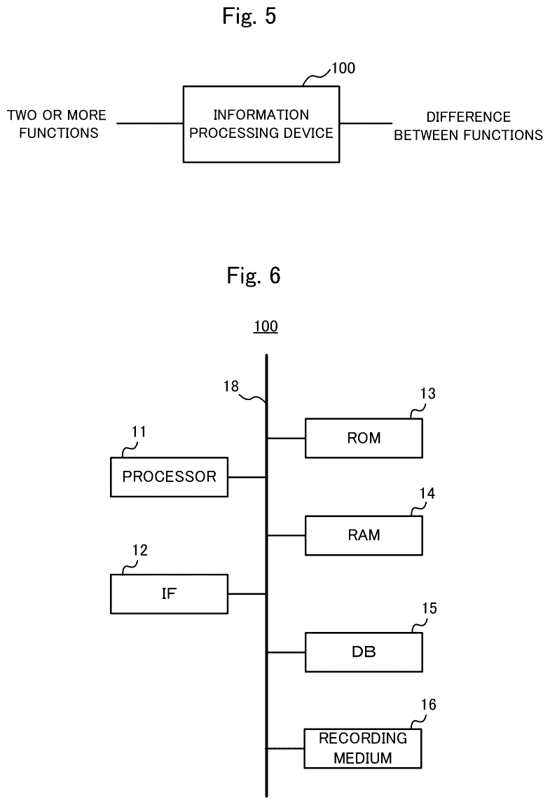

FIG. 5 illustrates an overall configuration of an information processing device according to a first example embodiment. Two or more functions to be compared are input to an information processing device 100. The information processing device 100 compares the two or more functions that have been input and outputs a difference between the functions by using the above proposed technique.

### (Hardware Configuration)

FIG. 6 is a block diagram illustrating a hardware configuration of the information processing device 100. As illustrated, the information processing device 100 includes a processor 11, an interface (IF) 12, a read only memory (ROM) 13, a random access memory (RAM) 14, a database (DB) 15, and a recording medium 16. The components are connected via a bus 18, for example.

The processor 11 is a computer such as a central processing unit (CPU), and controls the entire information processing device 100 by executing a program prepared in advance. Specifically, as the processor 11, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used.

The processor 11 loads a program stored in the ROM 13 or the recording medium 16 into the RAM 14, and executes each piece of processing coded in the program. The processor 11 functions as a part or all of the information processing device 100. Specifically, the processor 11 executes function comparison processing to be described later.

The IF 12 transmits and receives data to and from an external device. Specifically, the information processing device 100 acquires two or more functions through the IF 12, and outputs, to a display device or another external device, an index indicating the difference between the functions obtained by calculation.

The ROM 13 stores various programs executed by the processor 11. The RAM 14 is used as a working memory during execution of various types of processing by the processor 11.

The DB 15 stores various algorithms, data, machine learning models, and the like used when the information processing device 100 executes the function comparison processing to be described later.

The recording medium 16 is a non-volatile non-transitory recording medium such as a disk-shaped recording medium or a semiconductor memory. The recording medium 16 may be configured to be detachable from the information processing device 100. The recording medium 16 records various programs executed by the processor 11.

In addition to the above, the information processing device 100 may include a display device such as a liquid crystal display and an input device such as a keyboard and a mouse. The display device and input device are used by an operator of the information processing device 100, for example.

### (Functional Configuration and Processing)

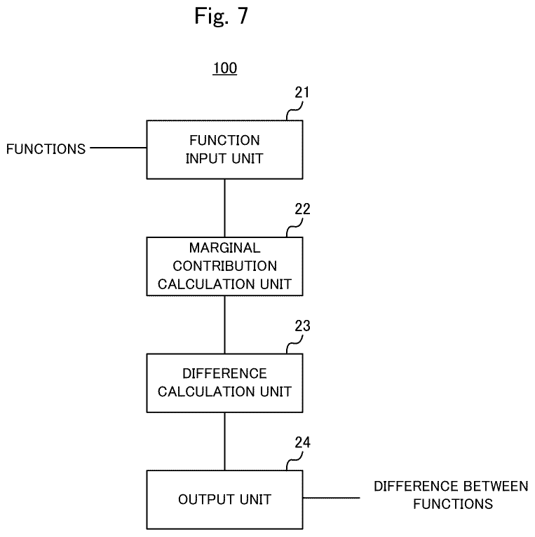

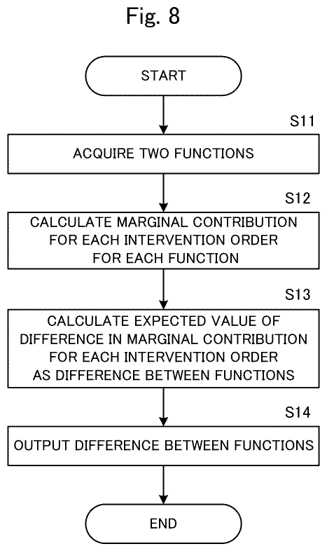

FIG. 7 is a block diagram illustrating a functional configuration of the information processing device. The information processing device 100 includes a function input unit 21, a marginal contribution calculation unit 22, a difference calculation unit 23, and an output unit 24. FIG. 8 is a flowchart of the function comparison processing executed by the information processing device 100. This processing is implemented by the processor 11 illustrated in FIG. 6 executing a program prepared in advance.

The function input unit 21 acquires two or more functions corresponding to prediction models (step S11). The marginal contribution calculation unit 22 calculates a marginal contribution for each intervention order of a feature i included in a set N for each function (step S12). For example, the marginal contribution calculation unit 22 calculates the marginal contribution using Formula (5) or (10) described previously.

The difference calculation unit 23 calculates an expected value of a difference in the marginal contribution for each intervention order as a difference between functions (step S13). Specifically, the difference calculation unit 23 calculates the difference between the functions using Formula (8) or (12) described previously. The output unit 24 outputs the obtained difference between the functions to a display device, an external device, or the like (step S14). Then, the function comparison processing ends.

### (Display Example)

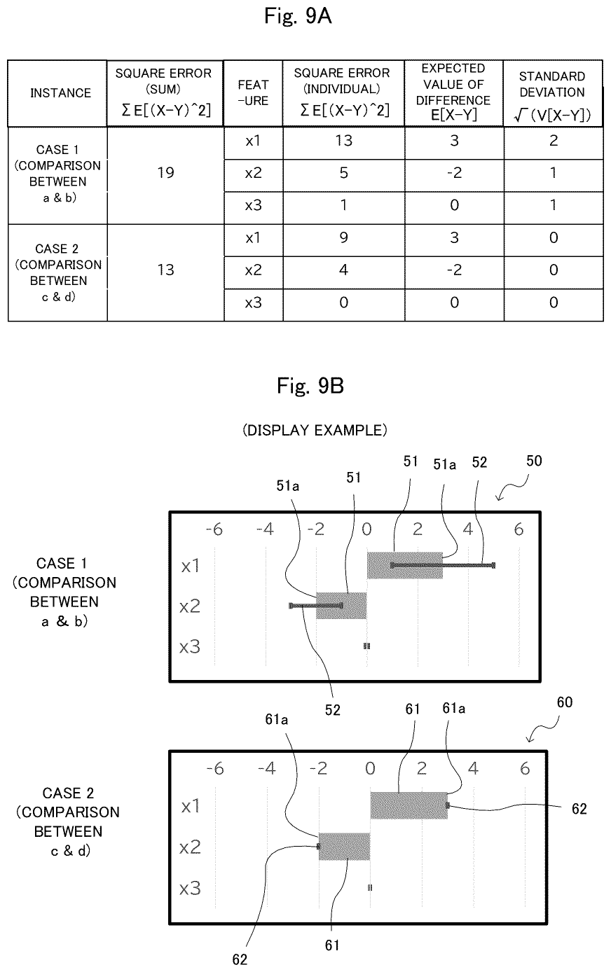

An explanation of a difference in prediction between instances obtained by the proposed technique can be visualized and presented to the user. FIGS. 9A and 9B illustrate a display example of the explanation of the difference in prediction between the instances. In this example, a case 1 in which instances a and b are compared and a case 2 in which instances c and d are compared are displayed.

In FIG. 9A, a “square error (individual)” indicates an individual square error for each of features x1 to x3, and a “square error (sum)” indicates a sum of the square errors of all the features x1 to x3. An “expected value of the difference” indicates the difference between the SHAP values, and corresponds to the bias term in the foregoing Formula (13). The “expected value of the difference” indicates an average magnitude of the index itself indicating the difference in prediction between the instances. A “standard deviation” indicates the difference caused by a difference in an interaction among the features x1 to x3, and corresponds to a variance term in the foregoing Formula (13). The “standard deviation” is a square root of a variance of the index indicating the difference in prediction between the instances, and indicates a fluctuation of the index indicating the difference in prediction between the instances.

All the “expected values of the differences” (=SHAP values) are equal between the case 1 in which the instances a and b are compared and the case 2 in which the instances c and d are compared. However, since the “standard deviations” (=square root of variance) are different, actual distances between the instances (=sum of square errors) are also different.

A graph 50 in FIG. 9B shows the case 1 in which the instances a and b are compared, and ends 51a of bars 51 corresponding to the features x1 and x2 indicate the “expected values of the differences”. Since the “expected value of the difference” of the feature x3 is 0, the bar 51 is not displayed. Bars 52 corresponding to the features x1 and x2 indicate the “standard deviations”, and the graph 50 indicates that there is an interaction between the features.

Similarly, a graph 60 in FIG. 9B shows the case 2 in which the instances c and d are compared, and ends 61a of bars 61 corresponding to the features x1 and x2 indicate the “expected values of the differences”. Since the “expected value of the difference” of the feature x3 is 0, the bar 61 is not displayed. In the graph 60, the “standard deviations” corresponding to the features x1 to x3 are “0”, and thus bars corresponding to the bars 52 in the graph 50 are not illustrated. This indicates that there is no interaction between the features.

As described above, the case 1 in which the instances a and b are compared and the case 2 in which the instances c and d are compared show the same “expected values of the differences” corresponding to the SHAP values, but show different “standard deviations” indicating the interactions between the features. It is therefore possible to determine whether there is an interaction between features by referring to such a display example.

### Modified Example of Proposed Technique

### First Modified Example

The above proposed technique can be applied between two instance sets. As described below, when a certain prediction model is given, an explanation of a difference in prediction between instance sets X_{A} and X_{B} can be defined by the following index.

$${E}_{{x}_{A} \cdot {x}_{B} \cdot π \cdot b} [ {( {Δ}_{π , b , {x}_{A}}^{( i )} - {Δ}_{π , b , {x}_{B}}^{( i )} )}^{2} ] \qquad ( 14 )$$

As a result, the proposed technique can be used to explain a difference in prediction between clusters. For example, in a task of purchase prediction, when there is a difference in a predicted purchase amount between twenties (cluster 1) and fifties (cluster 2), it is possible to know which product involves a difference in purchase and has caused the difference.

### Second Modified Example

When the proposed technique is used, it is possible to speed up arithmetic processing with a focus on features used by a model for prediction. The following observations exist regarding the features used for prediction.
(1) When there is a feature that does not affect prediction of the model, the marginal contribution related to the feature is 0.
(2) For a plurality of feature sets S in which the marginal contribution of the feature i to the feature set S is the same, the marginal contributions can be calculated collectively.

Focusing on the fact that the above two matters are particularly likely to occur in a tree structure model, the following Document 2 proposes an algorithm for obtaining a SHAP value corresponding to the tree structure model at high speed.
(Document 2) Explainable AI for Trees: From Local Explanations to Global Understanding, Scott M. Lundberg et. al. arXiv2019 1905.04610 (arxiv.org).

When a branch condition of a certain internal node in a tree structure model focuses on a feature j, all destinations are identical in a case where a set S that has reached the node includes the feature j, and all destinations are identical also in a case where the set S does not include the feature j. Thus, it is possible to speed up the processing by collectively performing processing for each of the case where the set that has reached the node includes the feature j and the case where the set does not include the feature j. Thus, the proposed technique also allows for extension based on the above observations (1) and (2). That is, it is possible to speed up the processing by collectively processing the plurality of feature sets S for each of instances of interest A and B based on the observations (1) and (2).

### Application Examples of Proposed Technique

### First Application Example

The proposed technique can be used for an application for finding a similar instance at high speed. Regarding an instance of interest, there is a need for finding an instance most similar to the instance of interest. In one example, in a case where a person has failed an examination in a credit trust, there is a need for finding an instance closest to oneself from among instances of passing the examination. In another example, in a case where a person has been diagnosed as a potential diabetic in a medical diagnosis, the person can set a goal regarding treatment by finding a person closest to oneself from among healthy people. In such a case, it is possible to address this need by setting a similarity function or a dissimilarity function as an index in the proposed technique and performing a nearest neighbor search for the instance of interest.

### Second Application Example

The proposed technique can be applied to clustering. As described previously, in a case where a difference in the Shapley value is simply used for an explanation of a prediction error between a plurality of instances, there is a problem that an error in an interaction is ignored when the evaluation is performed. On the other hand, in the proposed technique, it is possible to apply a high-speed algorithm based on a branch and bound method using an inequality relationship expressed by
difference between predicted values≤difference between SHAP values≤square error between marginal contributions.
   For example, in a case of analyzing good customers from purchase prediction results in purchase prediction of products or the like, it is possible to group together similar customers and formulate an efficient measure for each group.

### Second Example Embodiment

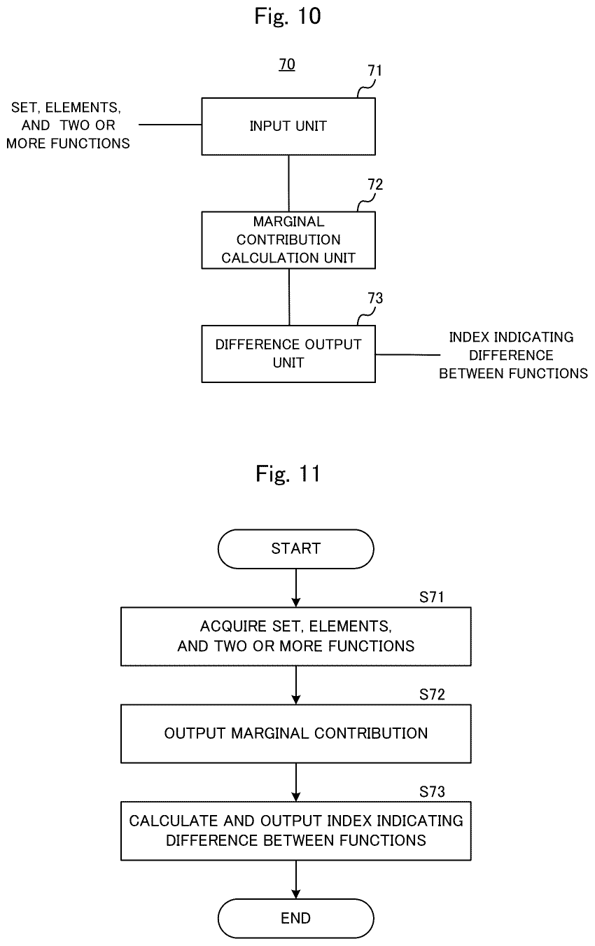

FIG. 10 is a block diagram illustrating a functional configuration of an information processing device according to a second example embodiment. An information processing device 70 according to the second example embodiment includes an input unit 71, a marginal contribution calculation unit 72, and a difference output unit 73.

FIG. 11 is a flowchart of processing by the information processing device according to the second example embodiment. The input unit 71 acquires a set, features included in the set, and two or more functions that return a value to an optional subset of the set (step S71). The marginal contribution calculation unit 72 outputs, as a marginal contribution, a difference between a first output value output by the functions in a case where a first subset of the set is input and a second output value output by the functions in a case where a second subset obtained by adding a feature to the first subset is input (step S72). The difference output unit 73 calculates and outputs an index indicating a difference between the functions based on the marginal contribution (step S73).

Some or all of the example embodiments described above may also be described as, but are not limited to, the following Supplementary Notes.

### (Supplementary Note 1)

An information processing device comprising:
an input means for acquiring a set, features included in the set, and two or more functions that return a value to an optional subset of the set;
a marginal contribution calculation means for calculating, as a marginal contribution, a difference between a first output value output by the functions in a case where a first subset of the set is input and a second output value output by the functions in a case where a second subset obtained by adding a feature to the first subset is input; and
a difference output means for calculating and outputting an index indicating a difference between the functions based on the marginal contribution.

### (Supplementary Note 2)

The information processing device according to Supplementary note 1, wherein the difference output means calculates, as the index indicating the difference between the functions, an expected value of a square error between the marginal contributions individually calculated for the functions.

### (Supplementary Note 3)

The information processing device according to Supplementary note 1, wherein the difference output means calculates, as the index indicating the difference between the functions, an expected value of a difference in the marginal contribution calculated for each of the functions for each order in which the features are input.

### (Supplementary Note 4)

The information processing device according to Supplementary note 1, wherein the marginal contribution calculation means calculates, as the marginal contribution, a difference between a value output by the functions in a case where the first subset selected from the set with a uniform probability is input and a value output by the functions in a case where the second subset obtained by adding the feature to the first subset is input.

### (Supplementary Note 5)

The information processing device according to Supplementary note 1, wherein the marginal contribution calculation means calculates, as the marginal contribution, a difference between a value output by the functions in a case where the first subset selected from the set in accordance with a certain probability distribution is input and a value output by the functions in a case where the second subset obtained by adding the feature to the first subset is input.

### (Supplementary Note 6)

The information processing device according to Supplementary note 1, wherein the difference output means visualizes and outputs, for display, a value indicating an average magnitude of the index itself indicating the difference between the functions, and a variance value indicating a fluctuation of the index.

### (Supplementary Note 7)

The information processing device according to Supplementary note 1, wherein the marginal contribution calculation means puts together a group of subsets among the set, in which the marginal contributions are equal, and calculates the marginal contribution for each group.

### (Supplementary Note 8)

An information processing method executed by a computer, the method comprising:
acquiring a set, features included in the set, and two or more functions that return a value to an optional subset of the set;
calculating, as a marginal contribution, a difference between a first output value output by the functions in a case where a first subset of the set is input and a second output value output by the functions in a case where a second subset obtained by adding a feature to the first subset is input; and
calculating and outputting an index indicating a difference between the functions based on the marginal contribution.

### (Supplementary Note 9)

A non-transitory computer-readable recording medium storing a program, the program causing a computer to execute processing comprising:
acquiring a set, features included in the set, and two or more functions that return a value to an optional subset of the set;
calculating, as a marginal contribution, a difference between a first output value output by the functions in a case where a first subset of the set is input and a second output value output by the functions in a case where a second subset obtained by adding a feature to the first subset is input; and
calculating and outputting an index indicating a difference between the functions based on the marginal contribution.

Some or all of the configurations described in Supplementary notes 2 to 7 dependent on the above-described Supplementary note 1 can also be dependent on Supplementary notes 8 and 9 by the same dependency relationship as in Supplementary notes 2 to 7. Furthermore, some or all of the configurations described as the Supplementary notes can be similarly dependent on not just Supplementary notes 1, 8, and 9, but also various pieces of hardware and software, various recording means for recording software, or systems without departing from the above-described example embodiments.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

11 Processor
21 Function input unit
22 Marginal contribution calculation unit
23 Difference calculation unit
24 Output unit
100 Information processing device

1. An information processing device comprising:
at least one memory configured to store instructions; and
at least one processor configured to execute the instructions to:
acquire a set, features included in the set, and two or more functions that return a value to an optional subset of the set;
calculate, as a marginal contribution, a difference between a first output value output by the functions in a case where a first subset of the set is input and a second output value output by the functions in a case where a second subset obtained by adding a feature to the first subset is input; and
calculate and output an index indicating a difference between the functions based on the marginal contribution.

2. The information processing device according to claim 1, wherein the at least one processor calculates, as the index indicating the difference between the functions, an expected value of a square error between the marginal contributions individually calculated for the functions.

3. The information processing device according to claim 1, wherein the at least one processor calculates, as the index indicating the difference between the functions, an expected value of a difference in the marginal contribution calculated for each of the functions for each order in which the features are input.

4. The information processing device according to claim 1, wherein the at least one processor calculates, as the marginal contribution, a difference between a value output by the functions in a case where the first subset selected from the set with a uniform probability is input and a value output by the functions in a case where the second subset obtained by adding the feature to the first subset is input.

5. The information processing device according to claim 1, wherein the at least one processor calculates, as the marginal contribution, a difference between a value output by the functions in a case where the first subset selected from the set in accordance with a certain probability distribution is input and a value output by the functions in a case where the second subset obtained by adding the feature to the first subset is input.

6. The information processing device according to claim 1, wherein the at least one processor visualizes and outputs, for display, a value indicating an average magnitude of the index itself indicating the difference between the functions, and a variance value indicating a fluctuation of the index.

7. The information processing device according to claim 1, wherein the at least one processor puts together a group of subsets among the set, in which the marginal contributions are equal, and calculates the marginal contribution for each group.

8. An information processing method executed by a computer, the method comprising:
acquiring a set, features included in the set, and two or more functions that return a value to an optional subset of the set;
calculating, as a marginal contribution, a difference between a first output value output by the functions in a case where a first subset of the set is input and a second output value output by the functions in a case where a second subset obtained by adding a feature to the first subset is input; and
calculating and outputting an index indicating a difference between the functions based on the marginal contribution.

9. A non-transitory computer-readable recording medium storing a program, the program causing a computer to execute processing comprising:
acquiring a set, features included in the set, and two or more functions that return a value to an optional subset of the set;
calculating, as a marginal contribution, a difference between a first output value output by the functions in a case where a first subset of the set is input and a second output value output by the functions in a case where a second subset obtained by adding a feature to the first subset is input; and
calculating and outputting an index indicating a difference between the functions based on the marginal contribution.
